(19) United States
(12) Patent Application Publication
(10) Pub. No.: US 2009/0051649 A1
(43) Pub. Date: Feb. 26, 2009

(54) Wearable display interface client

(75) Inventor: Stephen A. Rondel, Redmond, WA (US)

Correspondence Address: GRAYBEAL JACKSON LLP, 155 - 108TH AVENUE NE, SUITE 350, BELLEVUE, WA, 98004-5973, US

(73) Assignee: Conversational Computing Corporation, Redmond, WA (US)

(21) Appl. No.: 12/220,202

(22) Filed: Jul. 21, 2008

Related U.S. Application Data
(63) Continuation of application No. PCT/US2007/001804, filed on Jan. 22, 2007.
(60) Provisional application No. 60/761,018, filed on Jan. 20, 2006.
(60) Provisional application No. 60/802,149, filed on May 18, 2006.

(51) Int. Cl. G09G 5/00

(52) U.S. Cl. 345/156

(57) ABSTRACT

A wearable display interface that during operation is in short-range, wireless bidirectional communication with a server, related methods, and systems including the interface and server. The wearable interface includes a power supply driving a processor that is operatively coupled to a visual display and a wireless interface where the wearable display interface further includes an attachment interface for linking the display interface to a user's body, such as wrist or neck, or apparel. The server is preferably a mobile telephone where the display interface is a client. In addition, the interface can further function as a speaker and/or microphone to received and/or accept verbalized data, such as input instructions or communication commands. Intentional distribution of processing across the server and client ensures that the interface maintains a small and efficient form factor.

### SUMMARY OF THE INVENTION

The invention is directed to a wearable display interface that during operation is in short-range, wireless bidirectional communication with a server, related methods, and systems comprising the interface and server. The basic series of embodiments of the wearable interface according to the invention comprises a power supply driving a processor (general purpose or graphics, with or without onboard memory, with or without onboard display and other I/O driver(s)) that is operatively coupled to a visual display and a wireless interface where the interface further includes attachment means for linking the thin client to a user's body or apparel.

The attachment means in one line of embodiments functions to link the wearable interface with a user's wrist, preferably by way of a bracelet, while in another line of embodiments, the attachment means functions to link the wearable interface with a user's neck. In the first line of embodiments, the interface is intended to emulate a wrist watch, while in the second line of embodiments, the interface is intended to emulate a pendent or neck-worn locket.

A basic function of the wearable interface is to act as a wireless display device for a host server or master (hereinafter collectively referred to as “server” regardless of communication protocol conventions that may favor “host” or “master”; the wearable interface is referenced as a “client” even where the term “slave” may be more appropriate). Display data for the wearable interface can take the form of data encoding at least one visual image that is conditioned by the host server for display on the visual display or the host server native display data that is transformed by the wearable interface. A benefit of the former example is that bandwidth requirements for the wireless transmission of data encoding the at least one visual image is decreased and visual display refresh rates in the case of motion emulation images are increased due to the smaller size of a visual image being transmitted and transformed into an image on the visual display. However, an advantage of the later example is that the host server need not modify its visual display output to match the native display buffer size limitations of the wearable interface; these operations are handled by the interface.

The visual display of the wearable interface is preferably constructed from a high pixel density (high resolution or small pixel pitch) display constructed using liquid crystal display technology or organic light emitting diode technology. Alternative technologies include gyricon displays (see http://www2.parc.com/hsl/projects/gyricon/). An advantage associated with incorporating such a display is that power will only be used when refreshing the display. A benefit of using extreme low power displays is that an image may be continuously displayed without any power requirements. This technology enables a user of invention embodiments emulating a wrist watch, for example, to display any desired image without concern over power utilization in doing so. Displayed images may comprise watch face images or any other user-desired image.

Because of technology or cost limitations, obtaining a generally circular visual display may not be practical. In such instances, certain embodiments of the invention may further comprise a bezel that truncates a square display to approximate a circular display. The reduced display geometry may be coded into the wearable interface so that when the server transmits data encoding an image, the reduced display size is taken into account, or internal graphics processing of the wearable interface may transform the data accordingly, as previously described. Moreover, it is contemplated that a single visual display may be modified for non-technical or monetary reasons, i.e., fashion reasons. Snap-in bezels may be used to modify the aesthetic features of the wearable interface on an ad hoc basis. By sensing the type of bezel linked to the wearable interface, the visual display data may be suitably conditioned to fit within the observable display. Thus, each bezel type may have a unique identifier such as contactors, which identify the boundaries of the observable field of display, and permit either the wearable interface or server to modify the nature of the visual output to match the observable field.

A feature of the invention is the relatively short operative distance for bidirectional communication between the server and the wearable interface. Historically, wireless communication infrastructure has been directed to increasing the range between wireless nodes, thereby decreasing the capital investments necessary to establish the desired infrastructure, e.g., LEO satellite communications versus cellular towers. Alternatively, a large number of low-cost repeater nodes can be used, but this solution then requires more robust signal transfer technology and node linking infrastructure. To the contrary, the present invention is intended to reduce the effective bidirectional communication range to a relatively short distance, for example, 10 meters or less. Because the wearable interface is personal to the user, and because it relies upon distributed but local operations, the desired server will necessarily be located proximate to the user and is generally a constant resource. As will be described in more detail below, the invention is optimized for local use, and can rely upon a multitude of servers, but only if conflicts between them are minimized.

Thus, another feature of the invention is that the wearable interface is server non-specific. In one instance the host server can comprise a wireless communications device such as a cellular or PCS telephone. In this example, the user may have a speaker/microphone device (“audio device”) that is operatively coupled (preferably wirelessly) with the telephone, such as a Bluetooth enabled headset, while the wearable interface operates solely as a graphics (still or moving images) display device. In such an example, however, the telephone, which acts as a host server for both devices, must manage communications with both; if the telephone becomes inoperative, both visual and audio services are terminated. However, if the wearable interface also acts as a host for the audio device, then full display functionality can be restored upon encountering another suitable host server for the wearable interface (this is referred to as link passing where the wearable interface is passed from one server to another). For example, if the connection with the wireless telephone is lost, another connection may be established with a suitable wireless enabled personal computer whereupon information from the wireless telephone session (such as called or received telephone number stored in the wearable interface, or even stored audio input/output) can be passed to the new host server, and suitable action (such as establishing a VoIP connection with the called or received party) can be taken. Depending upon the protocol implemented, a user semi transparent handoff may take place so that there is little interruption in the voice and/or data communication between conversing or exchanging parties. If a plurality of viable servers are within bidirectional communication range of the wearable interface, then a prioritization scheme must be employed, which may be either dynamic or static. Dynamic assignments would require user input through a query-response session, while static assignments would give priority values to a plurality of possible servers. Prioritization can take into account proximity, e.g., a user's enabled cellular telephone has higher priority than a similarly enabled kiosk that is physically more distant, or can be purpose driven through the assessment of unique IDs and descriptive strings associated with each potential server.

Another feature of the invention is the use of the host server to perform robust computational functions, such as speech recognition. While prior efforts to enable a wearable appliance to engage in speech recognition attempted to have a single solution, embodiments of the present invention distributes the computational overhead for intensive applications such as speech recognition between a host server and the wearable interface. While the wearable interface need only function minimally as a “dumb terminal”, selected embodiments of the invention provide for the wearable interface to store user specific data concerning the user's voice patterns. In so doing, the host server need only have and operate a generic speech recognition software application such as Conversay's CASSI speech recognition engine (Conversational Computing Corporation, Redmond, Wash. USA). Once a suitable session has commenced, the host server application polls the wearable interface for a possible unique user acoustic file. Once accessed by or preferably temporarily copied to the server, the speech to text/action session will achieve exceptionally high translation accuracies. Moreover, the inclusion of a stored unique user acoustic file functions as a security device: only the authorized user's voice and speech characteristics will optimally drive the recognition application. To this end, the user acoustic file may be stored in non-volatile EEPROM or similar memory of the wearable interface, and may be secured by pass code to prevent unauthorized modification/removal/replacement of the data file.

Still another feature of the invention relates to the use of energy storage or generation devices, and their integration in various embodiments of the invention. With the rapid development of organic alternatives to conventional metal-based energy storage devices, the wearable interface can use flexible energy storage devices, preferably rechargeable, such as polymeric-based lithium-ion power cells. Alternatively, micro fuel cell technology can be employed wherein readily available fuel sources such as grain alcohol (Vodka, for example) can be used to generate electrical current for the device. Of course, conventional power storage devices such as dry cells (alkaline or other) can be used. The described power sources can be disposed within the housing or external to the housing.

Ideally, however, and to minimize the size of the housing for the display element and associated circuitry, it is considered beneficial to distribute the power storage and management components over the area occupied by the wearable interface. In embodiments wherein the display emulates a watch, the power supply is preferably housed on or comprises the attachment means for linking the wearable interface to the user. In selected such embodiments, the housing can be removable from the attaching means, such as a wrist band or bracelet. In this manner, the user can have two bracelets, one that is worn and one that is subject to stationary recharging. When the available power from the worn bracelet drops below a predetermined threshold, the user is notified of this fact and may then swap bracelets; a backup power source or non-volatile storage component operates to retain interface preferences and functions during this change-out. An advantage to these embodiments is that there is very little manipulation of the interface and the operation of switching power sources is very quick and easy. However, suitable means should be provided to prevent unintentional shorting of the power supply, such as using appropriate sealing technology between the housing and the bracelet (or between the power contacts and the environment), or using non-contacting power coupling means such as inductive couplings and others as will be appreciated by those persons skilled in the art.

As an alternative to the preceding embodiment example, other embodiments integrate the bracelet comprising a removable power source with the display housing. Because of this integration, there are not necessarily exposed power transfer contactors between the power source housing (e.g., bracelet) and the display housing, which reduces the risk of accidental shorting. However, replacement or recharging of the removable power source requires removal of the same for the duration of replacement or recharging, which may not be realistic for all users. As with the preceding embodiment example, an inductive charging system may be used to retain proper insulation of the power source from the environment, otherwise suitable barriers between the power source(s) and the environment should be used.

A similar approach in pendent form factors can be used where the necklace portion is functionally equivalent to the bracelet portion in the wrist embodiments. Furthermore, additional possibilities are available in a pendent form factor: one or more power cells can be “attached” to the necklace portion in an ornamental fashion (congruent to the necklace portion or orthogonal thereto) and exchanged upon depletion where the receiver for the power cell(s) is/are electrically coupled to the housing for the display.

Embodiments having a non-removable, rechargeable power source further require a charging source comprising a charging interface, which is preferably external to the device to retain the desired small form factor. The charging interface may take the form of a docking station or a discrete plug/receptacle form, the selection of which is considered a matter of design. Embodiments having a removable, rechargeable power source also require means for recharging the power source, although such means will likely emulate the housing in which such power source(s) is/are housed during use.

In selected embodiments, the wearable interface further comprises means for providing and/or receiving audio, whether via wireless link, e.g., a wireless headset, integrated structure, e.g., a speaker and/or microphone, or linked structure, e.g., retractable wired speaker and/or microphone. The following discussion is directed first towards audio output embodiments, then to audio input embodiments and finally to combination I/O devices. The disclosed embodiments are not intended to be exclusive, but are intended to demonstrate the diversity of applications and combinations of the disclosed technology.

Basic embodiments of the wearable interface having audio output capabilities may comprise an integrated speaker element.

Basic embodiments of the wearable interface having audio output capabilities may also comprise a wired, retractable speaker element, and, particularly a speaker element adapted to be inserted into the human ear canal. The wearable interface having audio output capabilities may be any of the type previously described, e.g., wrist worn or neck worn, and permits the user to extend a wired speaker there from. When the wired speaker is no longer needed, it may be retracted into the wearable interface. Advantages of these embodiments over integrated audio embodiments include increased privacy (audio output is presented directed to the user's ear canal and is exceptionally difficult to perceive by anyone but the user), decreased power consumption requirements since the audio is presented directly to the user's ear canal, increased audio fidelity and rejection of environmental noise, and other reasons appreciated by those persons skilled in the art.

Input: While speech recognition applications achieve greater transformational accuracy through the use of high quality microphones and related infrastructure (e.g., booms microphones, and preferably wireless headsets), restricting speech to text transformation to a limited vocabulary set drastically increases accuracy and thus overcomes the mechanical limitations that would otherwise decrease transformation accuracy. Moreover, pure voice communications, such as telephone conversations, are much more tolerant of quality limitations that might be found in an integrated microphone. Integrated speakers also encounter limitations in that transducer size and output is limited due to the desirably small form factor of the wearable interface (housing size, energy storage limitations, etc.). In this respect, and to provide sufficient flexibility, selected embodiments further comprise bidirectional communication aspects that permit the operator to operatively communicate with a remote audio input and output device, whether wired, wireless or integrated. In still other embodiments, such a remote audio input and output device is a removable component of the appliance: when docked with the appliance, the device approximates an integrated device; when removed and worn by the user, the device is characterized as a remote audio input and output device that is in wired or wireless communication with the wearable interface.

In selected embodiments, the wearable interface includes at least one analog to digital converter. Thus, analog input devices such as heart rate monitors or blood pressure monitors can be operatively coupled to the wearable interface. Similarly, analog output devices such as a speaker (previously described) or a vibrator can be operatively coupled thereto.

In addition to the foregoing, multiple input modes for the display are contemplated. Because an objective of the invention is to provide the user with convenient means for receiving and communicating data, conventional mechanical interface operations are to be minimized. For example, in certain environments a user may have the display present on his or her exterior clothing or garb, and the user may further be wearing gloves so that precision operation of his or her fingers is not possible. Exemplary environments include construction environments, underwater environments, cold weather environments, flight line environments, etc. In these situations, it may not be possible for the user to operate conventional push-buttons present on many wrist-worn devices, which are notoriously small and often crowded. Therefore, embodiments of the invention provide for proximity sensing means for performing select functions that otherwise would be responsive to push button switches, rotary knobs, and/or wheels. Such proximity sensing means include oriented thermal sensors, photo detectors, and ranging sensors such as ultrasonic transducers (either alone or in conjunction with emitters or other supporting infrastructure). A further benefit to this solid state approach is the elimination of seals commonly used to insulate the interior of the device from contaminants present in the environment.

The proximity sensing means can be unitary, thus approximating a single switch, or a plurality of such proximity sensing means can be used, thus approximating a plurality of switches. In embodiments wherein a plurality is used, portions of the display, housing and/or attachment means can be locations for the discrete sensing means. Alternatively, the display screen can be parsed into quadrants, for example, where covering an appropriate quadrant of the display screen will result in activation of the corresponding sensing means.

The sensing means can be time independent or time dependent. In time independent embodiments, the sensing means is a two state machine: activation of the sensing means will cause the state of a linked logic to change, regardless of how long the user “activates” the sensing means. In time dependent embodiments, the duration of “activation” will alter the state of a linked logic, such that, for example, “activation” for less than one second causes function “X” to be executed, while “activation” for more than 1 second but less than 5 seconds will cause function “Y” to be executed, and “activation” for more than 5 seconds will cause function “Z” to be executed. Thus, function “X” can be a “change screen” command; function “Y” can be a “scroll screen” command; function “Z” can be a “screen sleep” command. Moreover, embodiments of the invention incorporating such sensing means may utilize a series of “activations” in the alternative or in addition to foregoing, e.g., 3 time independent “activations” within 5 seconds, or 3 time dependent activations, such as “short”, “short”, “long”.

In addition to the foregoing, the sensing means can be arranged in an array, which lends itself to detection of relative motion in either one axis in the case of a linear array, or two axes in the case of a matrix array. Given the desirable objective of providing a small form factor for the display, a convenient location for establishing a linear array is on the attachment means for linking the display to a user's wrist. The linear nature of certain attachment means such as a strap-like configuration lends itself to a linear array, and further permits the user to perceive the display while “activating” the sensing means. This arrangement is further optimal for scrolling functions which benefit from motion derived input to control image display characteristics.

### BRIEF DESCRIPTION OF THE DRAWINGS

FIG. 1 is a schematic representation of an embodiment of the invention within a network;

FIG. 2 is a functional block diagram of the software residing in the watch interface embodiment of the invention and a host cellular telephone;

FIG. 3 is a detailed view of the display of the watch interface of FIG. 1;

FIG. 3a is a partial listing of high level APIs (class and hierarchy) of the watch interface of FIG. 1;

FIGS. 4-8 are various screens presented on the watch interface display during application selection, with sample utterances for the VUI; and

FIG. 9 is a sample SMS session using the watch interface of FIG. 1.

### DETAILED DESCRIPTION OF THE INVENTION EMBODIMENTS

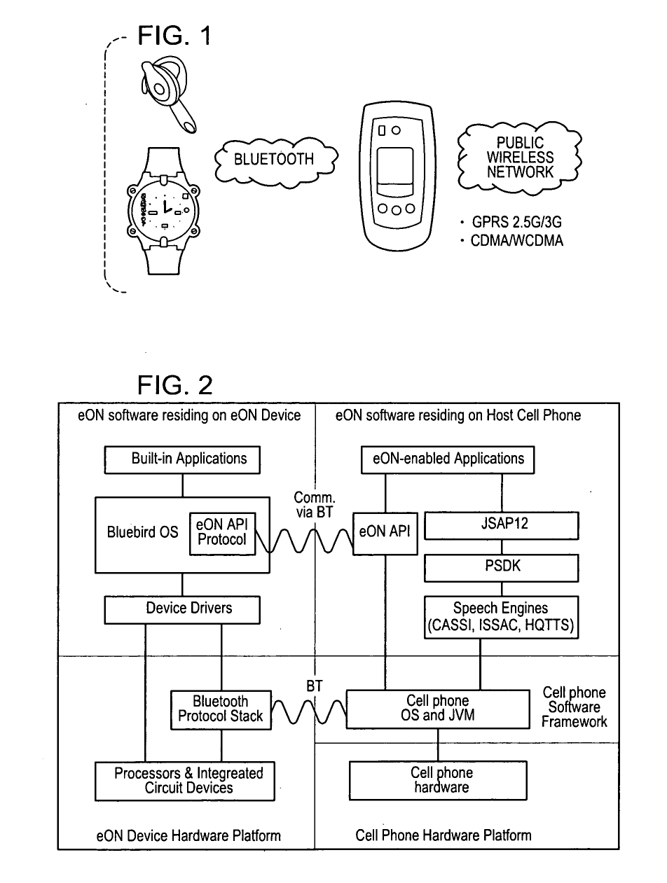

Turning then to FIG. 1, a basic embodiment of the wearable display of the invention in a wrist watch emulation form is shown (hereinafter “watch interface”), in conjunction with a wireless speaker/microphone (hereinafter “headset”) and a cellular telephone that is accessible by and to a public telephone network. Watch interface 10 provides a means for presenting visual information to a user via a high pixel-density matrix display; speech recognition software in cellular telephone 20 enables a user of headset 30 to voice commands, queries, statements and similar expressions without the requirement for a keyboard or other form of manual input, the results of which may be displayed on interface 10.

Watch interface 10 is constructed to visually and tactically mimic a traditional wristwatch, unlike prior efforts in the art that focused on mounting a communications appliance to the arm. Thus, the form factor of the watch interface is preferably within the bounds of conventional timepieces; adoption of new technology is facilitated by retaining an anchor to the known and accepted. In the illustrated embodiment of FIG. 1, the thickness is preferably 10 mm, while the basic diameter of the case is no more than approximately 50 mm.

From a hardware perspective, watch interface 10 comprises conventional watch components, namely a housing, which in turn includes a case, a back, and a crystal. Depending upon the embodiment, watch interface 10 may have a non-metallic bracelet or a metallic bracelet. In addition, one or a plurality of mechanical input means may be provided in selected embodiments, which may be SPST momentary contact type switches or a multifunction thumbwheel. In addition to or in lieu of mechanical switches, watch interface 10 may include “gesture” sensors. These sensors are non-contact forms of the described momentary switches. As long as watch interface 10 is in a lighted environment, occlusion of any “gesture” sensor, such as by covering it, will cause a change in logical state perceptible by the control circuitry in interface 10. This change can be treated like any switch, with the inclusion of suitable circuits. In addition, a secondary communication port may be employed, such as an infrared port.

Disposed in the case is an IC board on which are located an LCD display screen, an ARM 7 or ARM 9 processor, external flash memory, a piezo crystal, and a Bluetooth transceiver chip with associated antenna. The LCD display screen preferably has display characteristics of 160×128 pixels with 16 bit color depth (for a display of 256 colors). Software drivers present in the operating system described below provide the necessary hardware to software support. As noted in the Summary of the Invention section, a wide variety of alternative display screens are viable candidates, and presently include monochrome LCD displays, organic light emitting diode displays, and Gyricon displays. While not necessary to the operation of the various embodiments of the invention, it is considered highly desirable to have the display be a matrix display. It is also desirable to use displays having comparatively high pixel densities. Because of the relatively small form factor of the display, usability is greatly enhanced by having a high pixel density.

The processor is preferably a non-ASIC processor, a goal being to encourage third party development of applications for use with wearable interface 10 (establishing programs for an industry standard API is much easier). While many viable processors exist, those commonly used for the PDA market are considered desirable in that they are optimized for the PDA requirements of low power consumption, graphics display, and have industry standard APIs; various embodiments of the invention are targeted to a segment of such markets. Thus, the ARM 7 or ARM 9 processor chips are presently considered optimal for use. These chips preferably have developed programming interfaces, which further simplifies programming opportunities. In addition, a clock speed of at least 48 MHz and at least 64K of on-board RAM is considered desirable. The processor provides the resource requirements needed to implement all functionalities of watch interface 10.

The piezo crystal transducer is present for at least receipt confirmation of spoken and transformed instructions, manual inputs, and/or function changes instituted by the server. In addition, the crystal transducer can function for ring tone playback.

The Bluetooth chip provides wireless I/O functionality to watch interface 10. It is in bidirectional communication with the processor via a suitable driver and is otherwise integrated into the electronics package in a manner known to the skilled practitioner.

As noted in the Summary of the Invention section above, numerous power source options are available. Regardless of the power source location, a power source having a mAH rating of at least 530 at operating voltages has sufficient capacity to operate the presently contemplated embodiment for commercially reasonable times. In particular, the described electronics package will provide a generally static display image for approximately 16 hours with an average telecommunications duty cycle of 10%, while consuming about 500 mHA of power at rated voltage ranges. At full usage mode (described in detail below), a minimally equipped watch interface will operate for about 4 hours. Doubling the power source capacity results in an operational duration improvement of approximately 80%.

Operational power is provided by a plurality of power cells formed in the wristband or bracelet of watch interface 10. While a variety of power delivery modes are contemplated and are represented in the Summary of the Invention section, watch interface 10 uses a directly linked power source that is rechargeable via an inductive external charger.

As described earlier, watch interface 10 (also referred to in this section as “eON” or “eON device”) is a wristwatch emulation with an LCD display that interfaces with a Java enabled cellular telephone 20 through Bluetooth wireless protocol, and provides full voice control over the telephone and linked appliances in a system environment. The host cellular telephone 20 is preferably configured to run a plurality of speech-based applications in a Java Virtual Machine environment such as J2ME MIDP 2.0 (Java Platform, Micro Edition) (Mobile Information Device Profile JSR 118). In addition, such telephone preferably runs a JSAPI2 (Java Speech API 2.0, JSR 113) environment specifically created for speech applications on compact computing platforms such as smart phones. The speech-based applications, which are preferably firmware based, include speech recognition (SR) and text-to-speech (TTS) programs. These programs are preferably remotely upgradable via a suitable communications protocol access through the host cellular telephone, such as FTP.

The interactions between the cellular telephone (host) and the watch interface (client) is best shown in FIG. 2. Here, the client and host software infrastructure and hardware interactions are shown. The Bluebird operating system is a client-resident operating system, preferably stored in non-volatile memory. It includes event protocols for communicating with the cellular telephone via Bluetooth wireless protocol, as well as device driver protocols for with the electronics package of watch interface 10.

Built-in or resident applications operating under the Bluebird OS are those applications that run directly on watch interface 10 hardware, independent of wireless connectivity with a host or master. These applications preferably include time management, calendar, and task features, as well as a desired dial image.

Remote or host-based applications operating under a JVM environment are those applications that run directly on the host or master device, which in the case of the illustrated embodiment is cellular telephone 20. These applications preferably include data pass-through features such that data intended for display on telephone 20 is transmitted, either through redirecting or through transformation of the data, to watch interface 10. Also preferably included is an image display application for presenting a watch face image when watch interface 10 is not in functional use (non-time keeping use).

For enabling speech transformation functionality, preferred embodiments of watch interface 10 have applications that are functional under JSAPI2 environment.

In STT embodiments, at least one suitable speech engine must be employed to parse voiced input, and transform the spoken word to corresponding instructions for implementation by JSAPI2.

Finally, a library of APIs that provides access to speech engine functionalities as well as the Bluebird OS are available on the cellular telephone within the Software Developers Kit.

A feature of the described embodiment is the ability to switch from one host server (master) to another host server (master) either with user input or autonomously. If done autonomously, a signal comparator algorithm is employed that senses all available communications means (e.g., Bluetooth signals) and engages in bidirectional communications with one of them based upon user or default factors such as hosting abilities, signal strength, host type (nature of the hosting appliance), host purpose (alternative communications device or a priority device such as home automation controller). If a switch is to be made through user input, then the display presents iconic representations of the various host options for user selection. If no selection is made, the existing host configuration is retained. Of course, a hybrid approach may be employed: the user is given a period of time to select a new host or the existing host, after which time watch interface 10 does so autonomously. An optional confirmation message may be presented to the user, visually and/or audibly.

The following disclosure concerns the Graphical User Interface (“GUI”) and Voice User Interface (“VUI”) of watch interface 10. The GUI and VUI have been designed to work hand-in-hand to permit users to complete any given task by using either GUI or VUI or both.

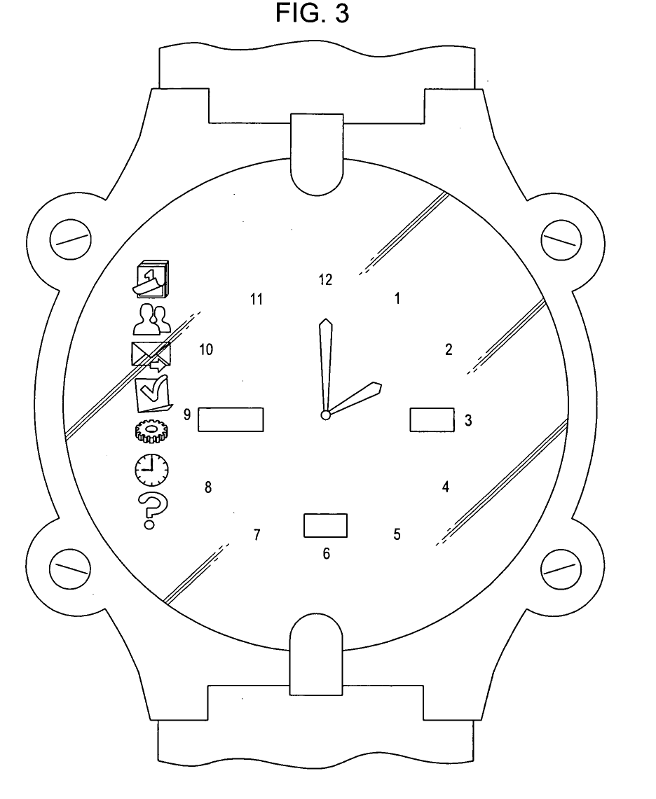

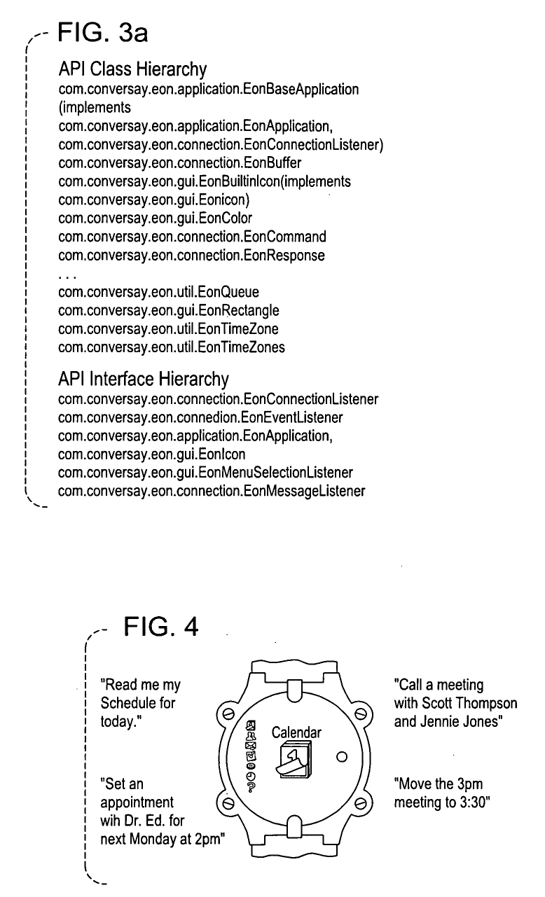

FIG. 3 illustrates a sample start up screen used to emulate a watch face. It includes a plurality of application icons in addition to a conventional analog watch face background image. A sample listing of available high level APIs corresponding to this state is shown in FIG. 3a. As with wallpapers and ring tones for cellular telephones, users of watch interface 10 may also acquire, save and display “watch-top” images (static or dynamic). These images may include those designed by brand name manufactures, which will provide both these entities as well as software developers the ability to create dynamic watch face displays that will redefine the fashion factor for wrist-worn timepieces.

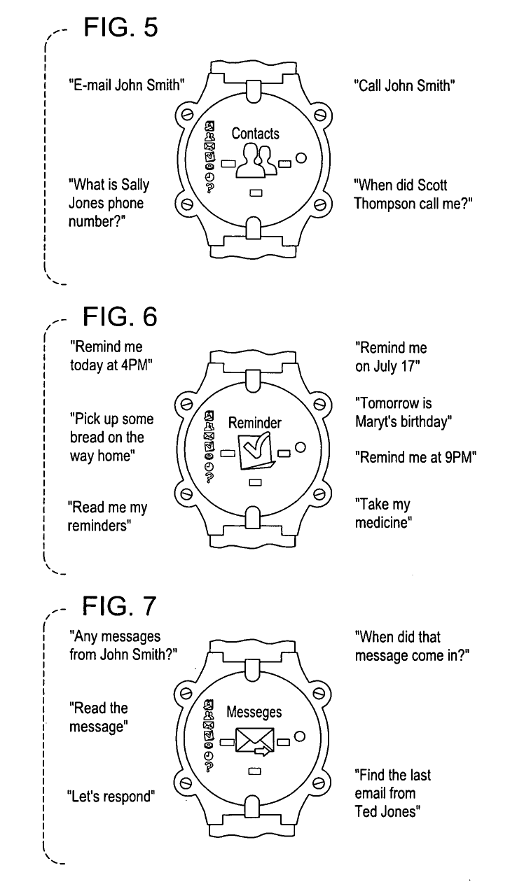

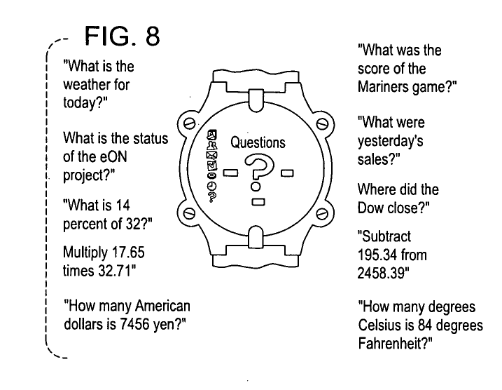

Should a user desire to invoke an application associate with a given icon, the user may manually select the icon such as by manipulating one or several of the mechanical input devices (e.g., switch(es) or thumbwheel). Or, the user may make the selection using the VUI, which has associated with each icon at least one voice utterance, e.g., “calendar”. In the illustrated embodiment, once an icon has been selected, confirmation of that selection takes the form of that icon being represented in larger form in the center of the display (FIG. 4). If not already loaded and running, the selected application is loaded into temporary memory and caused to run. Additional APIs associated with that program will also be invoked. FIGS. 5, 6, 7 and 8 illustrate additional voice commands for each of several common applications found in watch interface 10 (watch, desktop, calendar, contacts, messages, reminders and questions). Additional applications subject to user selection include ring tones, call control, weather, settings, internet browser, calculator, skins, email, translator, music, forms, video, currency conversion, task, notes and SMS.

It should be noted that the lexicon for the speech engine resident in the cellular telephone memory may be modified to exploit the common vocabulary and grammar associated with the selected application, thereby increasing accuracy and speed of the search engine. This feature is referred to as application specific lexicon. This selective vocabulary greatly reduced computational overhead, and thus prolongs what may be considered limited power source resources.

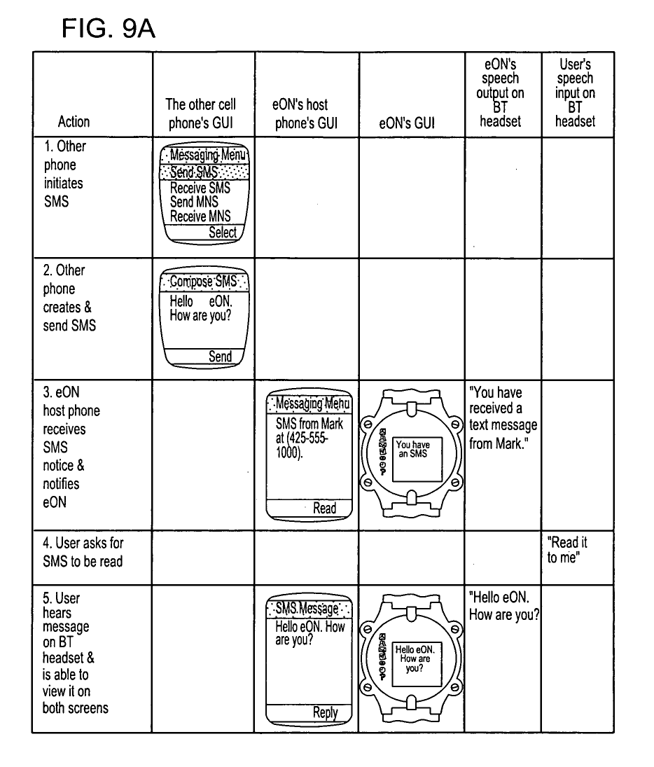

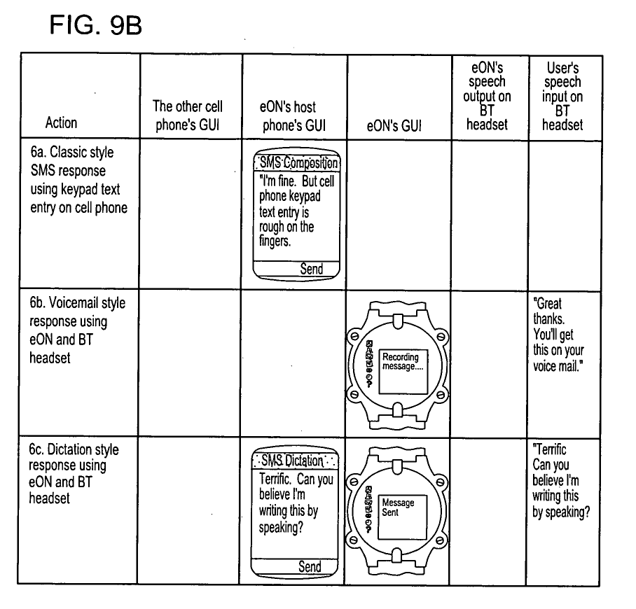

Turning then to FIG. 9, a sample session of an SMS exchange using the GUI and VUI interfaces is shown and described. SMS (Short Messaging Service) is among the various messaging applications including email and text messaging used by over 60 million U.S. consumers. SMS is a service that permits exchange of short text messages between mobile telephones. Popular among teens, but also increasingly used in business interactions, SMS presents both novice and experienced users with the challenge of typing letters on a small, cramped and counterintuitive keypad. In the referenced Figure, a typical SMS session on watch interface 10 is shown, and particularly the interactions between the various components in watch interface network architecture, and illustrated what a user may see, say and hear.

1. A wearable video display interface that during operation is in short-range, wireless bidirectional communication with a server operatively linked to a telecommunications network, and running speech recognition software to transform spoken utterances from a sound input device into text strings usable by the server to perform one of functions, data population or a combination of functions and data population, and further running software to communicate data encoding a visual image to the interface via a wireless transceiver, the interface comprising:
a housing and means for substantially encircling a body portion of a human user;
an electronics package substantially surrounded by the housing and comprising
a processor, a matrix display, a memory and command input means, all operatively coupled together, and to which power is supplied by a power source; and
a wireless transceiver operatively coupled to the processor to receive data from the server and transmit data to the server.

2. The wearable display interface of claim 1 wherein the maximum effective transmission and reception range of the interface is about 10 meters.

3. The wearable display interface of claim 1 wherein the display interface transmits and receives data using the Bluetooth protocol.

4. The wearable display interface of claim 1 wherein the sound input device comprises a microphone physically and operatively separate from the display interface.

5. The wearable display interface of claim 1 wherein the sound input device comprises a microphone physically and operatively associated with the display interface.

6. The wearable display interface of claim 1 wherein the means for substantially encircling a body portion of a human user comprises one of a bracelet or a necklace.

7. The wearable display interface of claim 1 the power source is integrated with the means for substantially encircling a body portion of a human user.

8. The wearable display interface of claim 1 wherein the housing has no human digit responsive physical input means for normal operation of the display interface.

9. The wearable display interface of claim 1 wherein the display interface comprises a user voice-derived data file that can be used by the server to increase speech to data transformation accuracy, increase speech to data transformation speed and/or serve as a unique identifier for the display interface.

10. The wearable display interface of claim 1 wherein the display comprises organic light emitting diodes.

11. A wearable video display interface that during operation is in short-range, wireless bidirectional communication with a mobile telephone operatively linked to a telecommunications network, and running speech recognition software to transform spoken utterances from a sound input device into text strings usable by the server to perform one of functions, data population or a combination of functions and data population, and further running software to communicate data encoding a visual image to the interface via a wireless transceiver, the interface comprising:
a housing and means for substantially encircling a body portion of a human user;
an electronics package substantially surrounded by the housing and comprising a processor, a matrix display, a memory and command input means, all operatively coupled together, and to which power is supplied by a power source; and
a wireless transceiver operatively coupled to the processor to receive data from the mobile telephone and transmit data to the mobile telephone.

12. The wearable display interface of claim 11 wherein the maximum effective transmission and reception range of the interface is about 10 meters.

13. The wearable display interface of claim 11 wherein the display interface transmits and receives data using the Bluetooth protocol.

14. The wearable display interface of claim 11 wherein the sound input device comprises a microphone physically and operatively separate from the display interface.

15. The wearable display interface of claim 11 wherein the sound input device comprises a microphone physically and operatively associated with the display interface.

16. The wearable display interface of claim 11 wherein the means for substantially encircling a body portion of a human user comprises one of a bracelet or a necklace.

17. The wearable display interface of claim 11 the power source is integrated with the means for substantially encircling a body portion of a human user.

18. The wearable display interface of claim 11 wherein the housing has no human digit responsive physical input means for normal operation of the display interface.

19. The wearable display interface of claim 11 wherein the display interface comprises a user voice-derived data file that can be used by the server to increase speech to data transformation accuracy, increase speech to data transformation speed and/or serve as a unique identifier for the display interface.

20. The wearable display interface of claim 11 wherein the display comprises organic light emitting diodes.
